(19) United States
(12) Patent Application Publication
(10) Pub. No.: US 2012/0044149 A1
(43) Pub. Date: Feb. 23, 2012

(54) MISINPUT AVOIDANCE METHOD FOR MOBILE TERMINAL

(75) Inventors: Dong Kyun Son, Suwon-si (KR); Dong Han Kang, Suseong-gu (KR); Woo Chan Park, Suseong-gu (KR); Jong Soo Woo, Dalseo-gu (KR); Sang Hoon Kang, Suwon-si (KR)

(73) Assignee: SAMSUNG ELECTRONICS CO., LTD., Suwon-si (KR)

(21) Appl. No.: 13/213,926

(22) Filed: Aug. 19, 2011

(30) Foreign Application Priority Data
Aug. 20, 2010 (KR) 10-2010-0080914

(51) Int. Cl. G06F 3/023

(52) U.S. Cl. 345/169

(57) ABSTRACT

A misinput avoidance method of a mobile terminal may be implemented to prevent a misinput caused by contacting unintended keys around the target key. A misinput avoidance method of a mobile terminal according to the present invention includes detecting inputs of a plurality of keys and discriminating a target key from other keys. The method also includes extracting keys around the target key and registering the keys around the target keys as neighbor keys. The method further includes processing the input of the target key while blocking the inputs of the neighbor keys. The method further includes releasing, when the target key is released, the blocking of the inputs of the neighbor keys.

### CROSS-REFERENCE TO RELATED APPLICATION(S) AND CLAIM OF PRIORITY

The present application is related to and claims the benefit under 35 U.S.C. §119 a of a Korean patent application filed in the Korean Intellectual Property Office on Aug. 20, 2010 and assigned Serial No. 10-2010-0080914, and the entire disclosure of which is hereby incorporated by reference.

### TECHNICAL FIELD OF THE INVENTION

The present invention relates to a mobile terminal and, in particular, to a misinput avoidance method of a mobile terminal for avoiding misinputs made by contacting unintended keys around a target key.

### BACKGROUND OF THE INVENTION

With the advance of data communication and semiconductor technologies, the use of mobile terminals is widespread and the number of users is increasing rapidly. Recently, the mobile terminals are evolving into multifunctional devices integrating various functions in line with the mobile convergence tendency. For example, a recent mobile communication terminal integrates various multimedia functions including TV (Television) functions such as DMB (Digital Multimedia Broadcasting) and DVB (Digital Video Broadcasting), music player functions (e.g., MP3 (MPEG Audio Layer-3)), camera functions, Internet functions, and electronic dictionary functions, as well as the conventional communication functions such as voice and message communication.

Recent mobile terminals are equipped with various types of input devices. For example, a mobile terminal can be provided with at least one of a 3×4 keypad, 4×3 keypad, a QWERTY keypad, a touch keypad, and a virtual keypad. Since the input device of a mobile terminal has to provide a plurality of keys in a limited space, each key is relatively small in size.

Accordingly, the conventional mobile terminal has a drawback in that the user may be likely to make a misinput by contacting unintended keys densely arranged around the target key. In order to avoid such a misinput, various methods have been proposed. For example, one of the representative methods is a sensor-assisted method in which a controller recognizes the key based on the measurement provided by at least one sensor for sensing the human body temperature characteristics and electric current characteristics. However, the conventional method has a drawback in that the whole manufacturing cost of the mobile terminal increases due to the sensors and additional software.

### SUMMARY OF THE INVENTION

The present invention provides a misinput avoidance method for a mobile terminal that is capable of avoiding the misinput caused by contacting unintended keys around the target key in the space-constrained input device.

Also, the present invention provides a misinput avoidance method for a mobile terminal having an input device that is capable of reducing misinput caused by contacting keys around the target key unintentionally.

Also, the present invention provides a misinput avoidance method for a mobile terminal having an input device that is capable of providing the user with an optimized key input environment, resulting in reduction of misinputs caused by contacting unintended keys around the target.

Furthermore, the present invention provides a misinput avoidance method for a mobile terminal equipped with an input device that allows the user to input efficiently without misinput, resulting in improvement of user's convenience and usability.

In accordance with an aspect of the present invention, a method for avoiding misinput for a mobile terminal includes detecting an input and checking a target key corresponding to the input and neighbor keys around the target key. The method also includes blocking inputs of the neighbor keys before the target key is released.

In accordance with another aspect of the present invention, a misinput avoidance method of a mobile terminal includes detecting inputs of a plurality of keys and discriminating a target key from other keys. The method also includes extracting keys around the target key and registering the keys around the target keys as neighbor keys. The method further includes processing the input of the target key while blocking the inputs of the neighbor keys. The method further includes releasing, when the target key is released, the blocking of the inputs of the neighbor keys.

In accordance with another aspect of the present invention, a misinput avoidance method of a mobile terminal is stored in a computer-readable storage medium in the form of computer-executable program.

In accordance with still another aspect of the present invention, a mobile terminal includes an input unit which receives an input of a key. The mobile terminal also includes a control unit configured to discriminate, where a plurality of keys are input by means of the input unit, a target key from other keys among the plurality of keys, and block inputs of the other keys before the target key is released.

Some features and advantages of the present invention have been generally described in this summary section, however, additional features, advantages, and embodiments are presented herein or will be apparent to those skill in the art in view of the drawings, specification, and claims hereof. Accordingly, it should be understood that the scope of the invention shall not be limited by the particular embodiments disclosed in this summary section.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a configuration of a mobile terminal according to an embodiment of the present invention;

FIG. 2 illustrates an algorithm for implementing the misinput avoidance method for a mobile terminal according to an embodiment of the present invention;

FIG. 3 illustrates a key map for explaining the principle of the misinput avoidance method of a mobile terminal according to an embodiment of the present invention;

FIG. 4 illustrates a method for avoiding a misinput in a mobile terminal according to an embodiment of the present invention; and

FIG. 5 illustrates a method for avoiding a misinput in a mobile terminal according to an embodiment of the present invention.

### DETAILED DESCRIPTION OF THE INVENTION

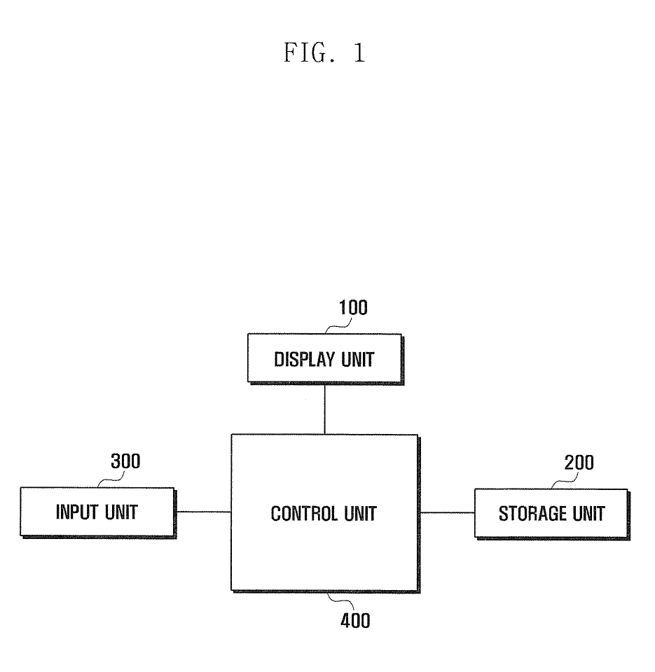

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile terminal. Detailed description of well-known functions and structures incorporated herein may be omitted to avoid obscuring the subject matter of the present invention. That is, the description is made only with the operations necessary in the embodiments of the present invention, and other parts that may cause obscurity of the subject matter of the present invention are omitted.

The present invention relates to a method and apparatus for avoiding a misinput caused by contacting unintended keys around the target key in a mobile terminal having a space-constrained input device. The mobile terminal includes at least one of a 3×4 keypad, a 4×3 keypad, a QWERTY keypad, a touch keypad, and a virtual keypad. Such an input device is provided with a plurality of keys. For this reason, it is possible that the user may make a misinput by contacting unintended keys around the target key during the manipulation of the space-constrained input device, and the present invention aims to prevent the unintended keys from being input. In an embodiment of the present invention, the unintended keys are the keys arranged around the key which the user wants to select in the input device.

A description is made of the configuration and operation of a mobile terminal according to an embodiment of the present invention with reference to FIGS. 1 through 5. Although the present invention is described with reference to the following embodiments and accompanying drawings, the present invention is not limited to the embodiments described, but can be practiced with modification and alteration within the spirit and scope of the appended claims.

FIG. 1 is a block diagram illustrating a configuration of a mobile terminal according to an embodiment of the present invention.

As shown in FIG. 1, the mobile terminal includes a display unit 100, a storage unit 200, an input unit 300, and a control unit 400. Although the mobile terminal can include at least one of a Radio Frequency (RF) unit, an audio processing unit having a microphone and a speaker, a digital broadcast (mobile broadcast such as DMB (Digital Multimedia Broadcasting) and DVB (Digital Video Broadcasting)) unit for receiving and playing broadcast signal, a camera unit for taking still/motion picture, a Bluetooth unit for short range Bluetooth communication, an Internet access unit for supporting Internet access, and a touchscreen or touchpad for supporting touch input, detailed descriptions are omitted herein.

The display unit 100 displays execution screens of the applications running in the mobile terminal. For example, the display unit 100 displays the execution screens of the messaging applications, email applications, Internet access applications, multimedia playback applications, browser applications, communication applications, electronic book (e-book) applications, still/motion picture capturing applications, still/motion picture playback applications, TV playback applications (e.g., mobile broadcasting such as DMB and DVB), music playback applications (e.g., MP3 player), widget applications, memo applications, and game applications. The display unit 100 can be implemented with any of Liquid Crystal Display (LCD), Organic Light Emitting Diode (OLED), Active Matrix OLED (AMOLED), and their equivalents. The display unit 100 displays the execution screen in one of landscape mode and portrait mode according to the posture of the mobile terminal.

According to an embodiment of the present invention, the display unit 100 can be provided with an input interface for supporting touch input. For example, the display unit 100 can be configured so as to detect the touch input made by the user on the screen, and send the corresponding input signal to the control unit 400.

The storage unit 200 stores various programs and data processed in the mobile terminal and includes at least one of volatile and nonvolatile memory devices. For example, the storage unit 200 can stores the Operating System of the mobile terminal, the application program and data related to the display control operation of the display unit 100, the application program and data related to the input control operation of the display unit 100, and the application program and data related to the input control operation of the input unit 300, temporarily or semi-persistently. Particularly, the storage unit 200 can store the key information on the keys selected unintentionally around the target key.

The input unit 300 detects the key manipulation made by the user and sends the input signal corresponding to the key manipulation to the control unit 400. The input unit 300 can include an input device and a plurality of function keys. According to an embodiment of the present invention, the input unit 300 includes at least one of the 3×4 keypad, 4×3 keypad, QWERTY keypad, and touch keypad. The input unit 300 supports the user input made by means of one of the input devices and sends the input signal generated based on the user input to the control unit 400.

According to an embodiment of the present invention, the input unit 300 can include the virtual keypad provided by means of the display unit 100. The virtual keypad can be provided in the form of one of the 3×4 key arrangement, 4×3 key arrangement, and QWERTY key arrangement. The input unit can include a plurality of keys (buttons).

The control unit 400 controls general operations of the mobile terminal. The control unit 400 can control execution of the instruction input by means of the display unit 100 or the input unit 300. Particularly when a key input is detected, the control unit 400 executes the instruction corresponding to the target key while blocking the misinputs made by the keys around the target key until the target key is released.

In detail, when a key input made by the input device is detected, the control unit 400 discriminates the first activated key from the keys activated continuously around the first activated key. If a plurality of key inputs is detected, the control unit 400 regards the first detected key as the target key and extracts neighbor keys surrounding the target key with reference to the key matrix information stored in the storage unit 200.

Next, the control unit 400 locks the neighbor keys so as to not make a misinput. That is, the control unit 400 ignores the inputs made by the neighbor keys surrounding the target key. As a consequence, it is possible to avoid misinputs made by the keys around the target key unintentionally.

The control unit 400 executes the instruction made by the key input (e.g., displays a character input by means of the target key on the screen) and releases the lock of the neighbor keys when the target key is released. That is, when the target key release is detected, the control unit 400 unlocks the lock on the neighbor keys.

According to an embodiment of the present invention, the information (key codes) on the neighbor keys of the target key can be stored in the storage unit 200. That is, the control unit 400 can register the neighbor keys of the target keys. The control unit 400 ignores the inputs made by the neighbor keys but processes the input made by the target key. That is, even when several key inputs are detected, the control unit 400 ignores the inputs made by the neighbor keys around the target key. Afterward, when the target key is released, the control unit 400 unlocks the locks on the neighbor keys registered in the storage unit 200. That is, the registration of the neighbor keys is released by removing the information on the neighbor keys that is temporarily saved in the storage unit 200. With this algorithm according to an embodiment of the present invention, the inputs of the neighbor keys are blocked before the selection of the target key is released, resulting in avoidance of misinputs caused by the unintended keys. A description is made of the misinput avoidance method for the above-structured mobile terminal in association with the control operation of the control unit hereinafter.

The control unit 400 performs the control operations in association with other functions of the mobile terminal. For example, when an application is executed, the control unit 400 controls such that the application execution screen is displayed in synchronization with the operations of application. The control unit 400 also can receive the input signals sent by the display unit 100 and the input unit 300 and control the execution of the instructions indicated by the input signals.

The configuration depicted in FIG. 1 can be applied to any of a bar type terminal, a folder type terminal, a slide type terminal, a swing type terminal, and a flip type terminal. The mobile terminal can be any of various information communication devices, multimedia devices, and their equivalents. For example, the mobile terminal can be any of the portable devices including the mobile communication terminals operating with the communication protocols adopted to the corresponding communication systems, Portable Multimedia Player (PMP), Digital broadcast player, Personal Digital Assistant (PDA), Music player (e.g., MP3), portable game console, and smart phone.

Also, the misinput avoidance method according to an embodiment of the present invention can be applied to the large-size devices having the above-described input device such as TV (Television), LFD (Large Format Display), DS (Digital Signage), media pole, PC (Personal Computer), and laptop computer.

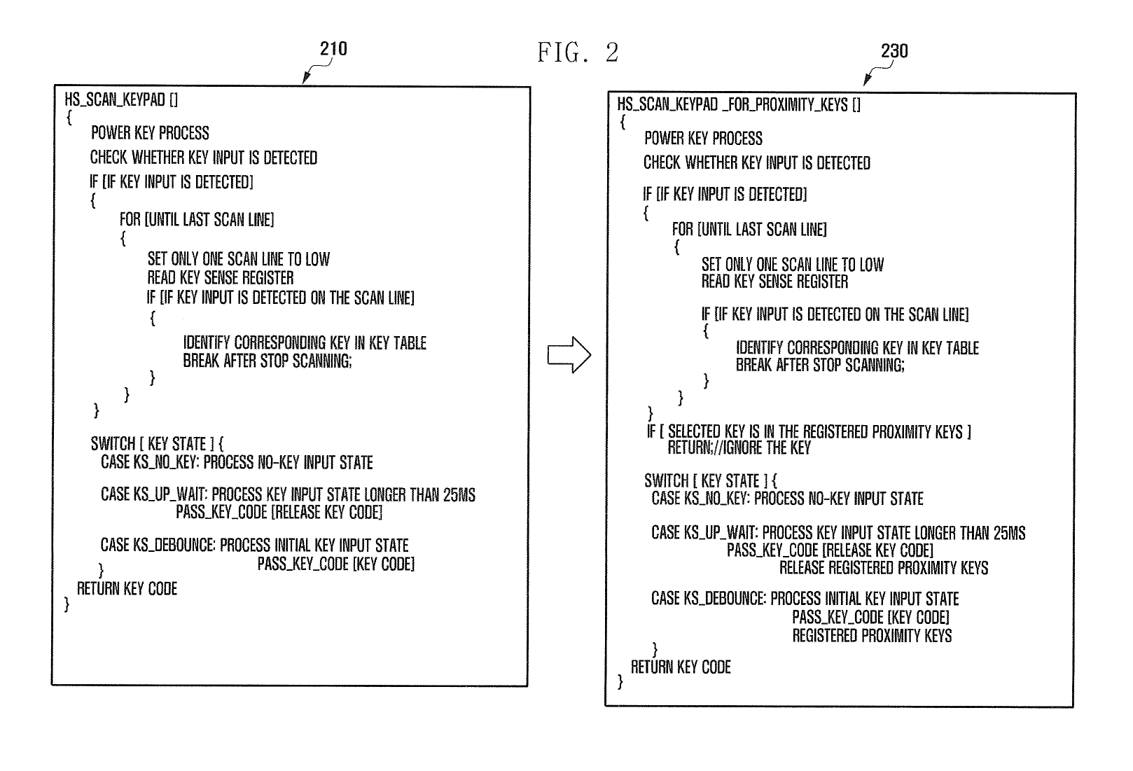

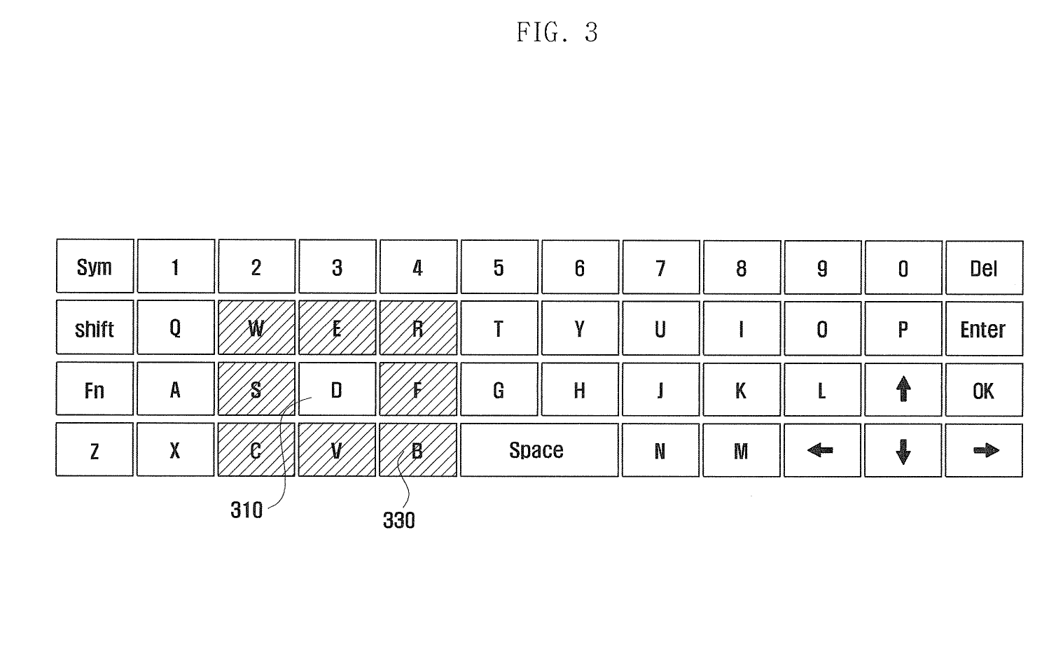

FIG. 2 is a diagram illustrating an algorithm for implementing the misinput avoidance method for a mobile terminal according to an embodiment of the present invention, and FIG. 3 is a diagram illustrating a key map for explaining the principle of the misinput avoidance method of a mobile terminal according to an embodiment of the present invention.

In order to compare key input operation principles in the normal key scan algorithm and the proposed key scan algorithm, Part 210 of FIG. 2 shows the normal key scan algorithm, and part 230 of FIG. 2 shows the key scan algorithm according to an embodiment of the present invention. In parts 210 and 230 of FIG. 2, KS_DEBOUNCE indicates the key selection state, and KS_UP_WAIT indicates the key release state.

Referring to FIG. 2, the conventional key scan algorithm as denoted by reference number 210 operates, as shown in KS_DEBOUNCE, such that, when a specific key is input through the input unit 300, the key code of the input key is sent to the control unit 400. As shown in KS_UP_WAIT, when the specific key is released, the Release key code is sent to the control unit 400.

In part 230 of FIG. 2, the key scan algorithm according to an embodiment of the present invention operates such that when a specific key is input through the input unit 300, the neighbor keys placed around the specific keys are locked immediately in software so as to avoid misinputs. The key codes of the neighbor keys are temporarily registered in the storage unit 200 to control such that the inputs made with the neighbor keys are ignored. As shown in KS_UP_WAIT, when the specific key is released, the release key code of the specific key is sent to the control unit 400 with the release of the lock on the neighbor keys that are registered in the storage unit 200 temporarily. For example, the temporarily registered neighbor key codes are erased to be initialized in the storage unit 200.

The key scan algorithm according to an embodiment of the present invention is locking, when the input of a specific key is detected, the neighbor keys around the specific key until the specific key is released, resulting in avoidance of the misinput caused by contacting the neighbor keys unintentionally. FIG. 3 shows how to register the neighbor keys in an embodiment of the present invention.

In FIG. 3, the key input device is depicted in the form of a QWERTY keypad which can be provided as a virtual keypad by means of the display unit 100 or a physical keypad by means of the input unit 300. That is, the input device according to an embodiment of the present invention can be implemented with one of a 3×4 keypad, a 4×3 keypad, a QWERTY keypad, and a touchpad provided by means of the input unit 300, and a virtual keypad provided by means of the display unit 100. In FIG. 3, reference number 310 denotes the target key intended by the user, and reference number 330 denotes the neighbor keys arranged around the target key 310.

In FIG. 3, it is assumed that the user intends to input the ‘D’ key 310. If the ‘D’ key 310 is input, the ‘W’ key, ‘E’ key, ‘R’ key, ‘F’ key, ‘B’ key, ‘V’ key, ‘C’ key, and ‘S’ key surrounding the ‘D’ key are registered as neighbor keys 330. That is, the key codes of the W′ key, ‘E’ key, ‘R’ key, ‘F’ key, ‘B’ key, ‘V’ key, ‘C’ key, and ‘S’ key are registered in the storage unit 300 so as to be managed as the neighbor key codes until the ‘D’ key is released. This means that the inputs of the neighbor keys 330 are locked before the release of the ‘D’ key 310.

Although the description is made with reference to the exemplary QWERTY keypad, the present invention is not limited thereto. The input device according to an embodiment of the present invention can include at least one of physical input means such as 3×4 keypad, 4×3 keypad, QWERTY keypad, and touch keypad. The input device according to an embodiment of the present invention can include a virtual keypad provided by the display unit 100, and the virtual keypad can be provided in one of 3×4 key formation, 4×3 key formation, and QWERTY key formation.

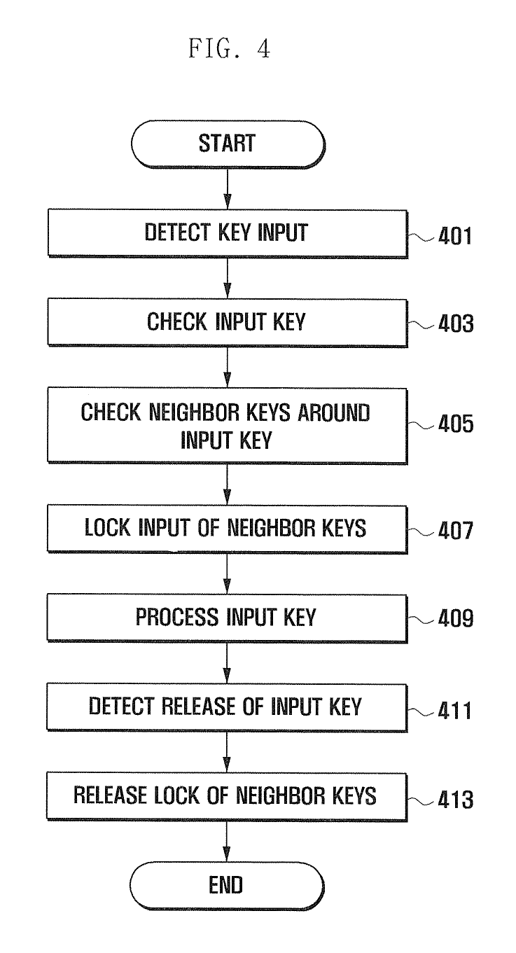

FIG. 4 is a flowchart illustrating a method for avoiding a misinput in a mobile terminal according to an embodiment of the present invention.

Referring to FIG. 4, the control unit 400 first detects a key input made by means of the input unit 300 (block 401). For example, if the user selects the ‘D’ key 310 as depicted in FIG. 3, the input device generates the input signal (i.e., key code) corresponding to the ‘D’ key and sends the signal to the control unit 400 and, upon receipt of the input signal, the control unit 400 detects the input of ‘D’ key 310.

Upon receipt of the input signal, the control unit 400 checks the input key corresponding to the input signal (block 403). The control unit 400 analyzes the input signal (key code) received from the input unit 300 and determines the key corresponding to the input signal. When more than one input signal is received, the control unit 400 discriminates the input signal received first from other input signals and regards the first input signal as the key input. That is, the control unit 400 regards the input signal received first prior to other input signals as the user's intended key input.

Next, the control unit 400 can check the neighbor keys around the input key (block 405). For example, if the ‘D’ key 310 is selected, the control unit 400 extracts the keys arranged around the ‘D’ key 310 and registers these keys as neighbor keys. The neighbor keys can be identified by referencing the key matrix information stored in the input unit 300, and the control unit 400 can discriminate the neighbor keys from each other with reference to the key matrix information.

Once the neighbor keys are extracted, the control unit 400 locks the neighbor keys around the target to avoid misinput (block 407). For example, the control unit 400 registers the key codes of the neighbor keys with the storage unit 200 and ignores the input made by means of the neighbor keys.

Next, the control unit 400 confirms the input of the target key (block 409). For example, the control unit 400 controls such that the character ‘D’ indicated by the ‘D’ key is displayed on the screen of the display unit 100.

Next, the control unit 400 detects the release of the target key (block 411). For example, if the user releases the selection of the ‘D’ key 310, the input device issues the ‘D’ key release signal (i.e., release key code) to the control unit 400, and upon receipt of the ‘D’ key release signal, the control unit 400 confirms the key release of the ‘D’ key.

Upon receipt of the key release signal, the control unit 400 releases the lock on the neighbor keys (block 413). For example, if the key release signal for the target key is received, the control unit 400 removes the key codes of the neighbor keys that are registered in the storage unit 200 and initializes the neighbor key registration.

As described with reference to FIG. 4, the control unit 400 can control such that the neighbor keys are locked until the selection of the target key is released. That is, the control unit 400 locks the neighbor keys before the release of target key input to avoid misinputs made by the neighbor keys.

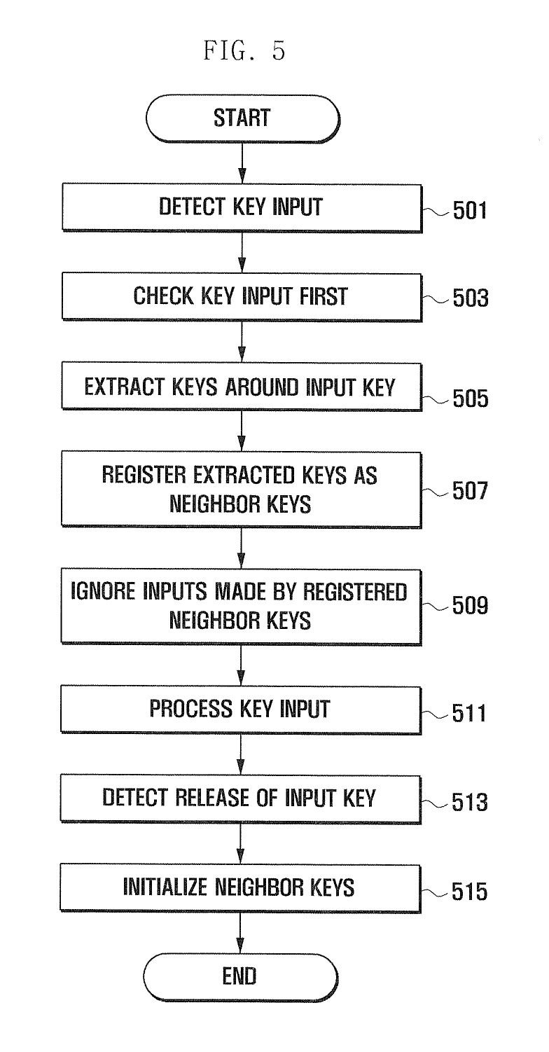

FIG. 5 is a flowchart illustrating a method for avoiding a misinput in a mobile terminal according to an embodiment of the present invention.

Referring to FIG. 5, the control unit 400 first detects at least one key input made by means of the input unit 300 (block 501). As aforementioned, if the user inputs a key by means of the input device, the input device issues an input signal corresponding to the input key to the control unit 400, and upon receipt of the input signal, the control unit 400 detects the key input. At this time, more than one key may be input by the user.

Upon receipt of the input signal, the control unit 400 checks the input key corresponding to the input signal (block 503). For example, the control unit 400 analyzes the input signal (key code) received from the input unit 300 and identifies the key corresponding to the input signal. When multiple key input signals are received, the control unit 400 discriminates the input signal received first from other input signals and identifies the target key corresponding to the input signal received first.

Next, the control unit 400 checks the keys around the target key (block 505). As aforementioned, the control unit 400 can extract the keys arranged around the target key with reference to the predefined key matrix information.

Next, the control unit 400 registers the keys around the target key as neighbor keys (block 507). For example, the control unit 400 registers the keys around the target key that are identified with reference to the predefined key matrix information as the neighbor keys in the storage unit 200. That is, the control unit 400 discriminates the neighbor keys from the target key and registers the key codes of the neighbor keys in the storage unit 200.

Next, the control unit 400 ignores the input made by any of the neighbor keys (block 509) and processes the input made by the target key (block 511). For example, the control unit 400 blocks the inputs corresponding to the key codes managed as the neighbor keys and processes only the input made by the target key.

Next, the control unit 400 detects the release of the target key (block 513). As aforementioned, if the user releases the selection on the target key, the input device issues a release signal (i.e., release code) to the control unit 400 such that the control unit 400 detects the release of the target key based on the release signal.

If the release of the target key is detected, the control unit 400 initializes the registration of the neighbor keys (block 515). For example, if the release signal of the target key is received, the control unit 400 removes the key codes of the neighbor keys that are registered in the storage unit 200 and initializes the registration.

As described above, the misinput avoidance method for a mobile terminal according to the present invention may be implemented to avoid misinputs caused by unintentionally contacting the keys around a target key on the space-constrained input device. The misinput avoidance method of the present invention can be applied to various portable devices supporting a physical input means provided by an input unit and a virtual input means provided on the display screen.

Also, the misinput avoidance method for a mobile terminal according to the present invention can block the input made by the keys around a target key, thereby avoiding unintended key inputs made by mistake without additional implementation cost. The misinput avoidance method of the present invention may be implemented to provide an efficient input environment with a space-constrained input device. Also, the misinput avoidance method of the present invention provides an efficient input environment of a mobile terminal having a space-constrained input device, resulting in improvement of usability, user convenience, and product competitiveness.

As described above, the misinput avoidance method of the present invention can be implemented in the form of program commands executable by means of various types of computers and recorded in a computer-readable storage medium. The computer-readable storage medium can store any or a combination of programs commands, data files, and data structure. The program commands recorded in the storage medium can be designed and structured according to the present invention, but may be the ones well-known to and practiced by those skilled in the art.

The computer-readable storage medium can be any of magnetic media including hard disk, floppy disk, and magnetic tape, optical media including Compact Disc Read Only Memory (CD-ROM) and Digital Versatile Disc (DVD), magneto-Optical Media including Floptical Disk, Read Only Memory (ROM), Random Access Memory (RAM), and Flash memory that can be configured to store the program commands. The program commands include high-level language codes that can be executable in the computer with the interpreter as well as machine language code produced by a compiler. The hardware device can be configured to operate in the form of more than one software module for performing the operation of the present invention and vice versa.

Although exemplary embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

Although the present disclosure has been described with exemplary embodiments, various changes and modifications may be suggested to one skilled in the art. It is intended that the present disclosure encompass such changes and modifications as fall within the scope of the appended claims.

What is claimed is:

1. A method for avoiding a misinput for a mobile terminal, the method comprising:
detecting an input;
checking a target key corresponding to the input and neighbor keys around the target key; and
blocking inputs of the neighbor keys before the target key is released.

2. The method of claim 1, wherein checking further comprises:
detecting inputs made to the neighbor keys; and
discriminating the input of the target key from the inputs of the neighbor keys.

3. The method of claim 2, wherein checking further comprises:
extracting adjacent keys around the target key; and
registering the adjacent keys as the neighbor keys.

4. The method of claim 2, wherein blocking further comprises processing the input of the target key while blocking the inputs of the neighbor keys.

5. The method of claim 2, wherein discriminating further comprises identifying a key detected first as the target key.

6. The method of claim 3, wherein registering further comprises registering key codes of the neighbor keys in a storage.

7. The method of claim 4, wherein blocking further comprises ignoring the inputs corresponding to the key codes of the neighbor keys.

8. The method of claim 7, further comprising:
releasing, when the target key is released, the blocking of the input of the neighbor keys.

9. The method of claim 8, wherein releasing further comprises erasing the key codes of the neighbor keys from the storage.

10. A misinput avoidance method of a mobile terminal, the method comprising:
detecting inputs of a plurality of keys;
discriminating a target key from other keys;
extracting keys around the target key;
registering the keys around the target keys as neighbor keys;
processing the input of the target key while blocking the inputs of the neighbor keys; and
releasing, when the target key is released, the blocking of the inputs of the neighbor keys.

11. The method of claim 10, wherein discriminating further comprises identifying a key detected first as the target key.

12. The method of claim 10, wherein registering further comprises registering key codes of the neighbor keys in a storage.

13. The method of claim 10, wherein blocking further comprises ignoring the inputs corresponding to key codes of the neighbor keys.

14. A mobile terminal, comprising:
an input unit configured to receive an input of a key; and
a control unit configured to discriminate, where a plurality of keys are input by means of the input unit, a target key from other keys among the plurality of keys, and block inputs of the other keys before the target key is released.

15. The mobile terminal of claim 14, wherein the control unit regards the key input earlier than other keys as the target key and extracts the keys around the target key with reference to key matrix information.

16. The mobile terminal of claim 15, wherein the control unit registers the keys around the target key as neighbor keys and releases, when the target key is released, the blocking of the inputs of the neighbor keys.

17. The mobile terminal of claim 14, wherein the input unit comprises at least one of a physical input device and a virtual keypad provided by a display unit.

18. The mobile terminal of claim 17, wherein the input unit comprises:
at least one of a 3×4 keypad, a 4×3 keypad, a qwerty keypad, and a touch keypad; and
a virtual keypad provided by the display unit.

19. The mobile terminal of claim 18, wherein the virtual keypad comprises at least one of a 3×4 key arrangement, a 4×3 key arrangement, and a qwerty key arrangement.

20. The mobile terminal of claim 14, further comprising a storage unit configured to store key codes of the plurality of keys.
